(19) United States
(12) Patent Application Publication
(10) Pub. No.: US 2014/0063410 A1
(43) Pub. Date: Mar. 6, 2014

(54) LIQUID CRYSTAL DISPLAY PANEL AND LIQUID CRYSTAL DISPLAY APPARATUS

(71) Applicants: INNOCOM TECHNOLOGY (SHENZHEN) CO., LTD, (US); INNOLUX CORPORATION, Miao-Li County (TW)

(72) Inventors: Shu-Han YU, Miao-Li County (TW); Yueh-Hsing LI, Miao-Li County (TW); Hung-Ze LIN, Miao-Li County (TW); Kai-Neng YANG, Miao-Li County (TW); Tsau-Hua HSIEH, Miao-Li County (TW)

(73) Assignees: INNOLUX CORPORATION, Miao-Li County (TW); INNOCOM TECHNOLOGY (SHENZHEN) CO., LTD, Shenzhen City (CN)

(21) Appl. No.: 13/846,153

(22) Filed: Mar. 18, 2013

(30) Foreign Application Priority Data
Aug. 31, 2012 (TW) 101131854

(51) Int. Cl. G02F 1/1337

(52) U.S. Cl. CPC G02F 1/133711; G02F 1/133723
USPC 349/61; 349/123

(57) ABSTRACT

A liquid crystal display (LCD) panel includes a first substrate, a second substrate, and a liquid crystal layer. The first substrate includes a first alignment layer. The second substrate is disposed opposite to the first substrate, and includes a second alignment layer. The liquid crystal layer is disposed between the first and second substrates, and the first alignment layer and the second alignment layer contact the liquid crystal layer. The first alignment layer and the second alignment layer are defined as first-type alignment layers, and either the first substrate or the second substrates has a second-type alignment layer.

### CROSS REFERENCE TO RELATED APPLICATIONS

This Non-provisional application claims priority under 35 U.S.C. §119(a) on Patent Application No(s). 101131854 filed in Taiwan, Republic of China on Aug. 31, 2012, the entire contents of which are hereby incorporated by reference.

### BACKGROUND

1. Technical Field

The invention relates to a display panel and a display apparatus and, in particular, to a liquid crystal display panel and a liquid crystal display apparatus.

2. Related Art

The liquid crystal alignment is one of the key technologies to determine the display quality of a liquid crystal display (LCD) device. Images can be displayed with high quality only when the liquid crystal molecules have a stable and even initial alignment. In general, an LCD device includes a thin film, which is called as liquid crystal alignment layer, for inducing alignment of liquid crystal molecules.

For manufacturing process, a rubbing method is often used to make liquid crystal molecules aligned evenly. In the rubbing method, for example, a polyimide (PT) layer is used to generate micro-grooves in parallel through mechanical rubbing, so that the alignment of liquid crystal molecules can be achieved.

However, static electricity and dust particles are generated during the rubbing method, which may cause damage to the thin film transistors or contamination to the liquid crystal molecules, and therefore the quality of the LCD apparatus is lowered down. Besides, the rubbing method needs additional processes which increase production time and cost.

Therefore, a conventional technology without use of polyimide alignment layer, which is called as PI-less or PI-free, is proposed. In such technology, the liquid crystal molecules mixed with monomers are disposed between two substrates, and then the monomers are polymerized through illumination so that two polymer alignment layers can be respectively formed on the surfaces of the two substrates contacting the liquid crystal layer. However, due to instability of alignment effect for the above-mentioned technology, bright dots or lines occur easily in the dark state, so that the production yield decreases.

Therefore, it is an important subject to provide a liquid crystal display panel and a liquid crystal display apparatus in which bright dots or lines can be prevented from occurring in the dark state when the PI-less process is applied, so that the production yield and the display quality can be improved.

### SUMMARY

In view of the foregoing subject, an objective of the invention is to provide a liquid crystal display panel and a liquid crystal display apparatus manufactured with PI-less process for preventing bright dots or lines from occurring in the dark state.

To achieve the above objective, a liquid crystal display (LCD) panel according to the invention includes a first substrate, a second substrate, and a liquid crystal layer. The first substrate includes a first alignment layer. The second substrate is disposed opposite to the first substrate, and includes a second alignment layer. The liquid crystal layer is disposed between the first and second substrates, and the first alignment layer and the second alignment layer contact the liquid crystal layer. The first alignment layer and the second alignment layer are defined as first-type alignment layers, and either the first substrate or the second substrate has a second-type alignment layer.

In one embodiment, the first and second substrates are composed of a color filter substrate and a thin film transistor substrate.

In one embodiment, the first-type alignment layer is a photo-induced polymer alignment layer, and the second-type alignment layer is a polyimide alignment layer.

In one embodiment, the first-type alignment layer is disposed between the second-type alignment layer and the liquid crystal layer.

In one embodiment, the first-type alignment layer is polymerized from a plurality of monomers. The monomers comprise mono-acrylic monomers, bi-acrylic monomers or a combination thereof. The mono-acrylic monomers are dodecyl prop-2-enoate. The bi-acrylic monomers are 4,4′-bisacryloyl-biphenyl or 4,4′-bis[4-(acryloyxy)hexyloxy]biphenyl.

In one embodiment, the thickness of the second-type alignment layer is between 100-1000 angstroms (Å).

In one embodiment, the thickness of at least one of the first and second alignment layer is less than 50 angstroms.

To achieve the above objective, a liquid crystal display apparatus according to the embodiments of the invention comprises a backlight module and a liquid crystal display panel disposed opposite to the backlight module and including a first substrate, a second substrate and a liquid crystal layer. The first substrate includes a first alignment layer. The second substrate is disposed opposite to the first substrate and includes a second alignment layer. The liquid crystal layer is disposed between the first substrate and the second substrate. The first alignment layer and the second alignment layer contact the liquid crystal layer, and are defined as first-type alignment layers. Either the first substrate or the second substrate has a second-type alignment layer.

As mentioned above, in the LCD panel and the LCD apparatus according to the embodiments of the invention, a second-type alignment layer such as polyimide alignment layer is only disposed on one substrate, and therefore the effectiveness of alignment can be enhanced when the PI-less process is conducted, so as to improve the yield and display quality by preventing bright dots and lines from occurring in the dark state.

### BRIEF DESCRIPTION OF THE DRAWINGS

FIG. 1 is a schematic diagram of a liquid crystal display panel according to an embodiment of the invention; and

FIG. 2 is a schematic diagram of a liquid crystal display apparatus according to an embodiment of the invention.

### DETAILED DESCRIPTION

The present invention will be apparent from the following detailed description, which proceeds with reference to the accompanying drawings, wherein the same references relate to the same elements.

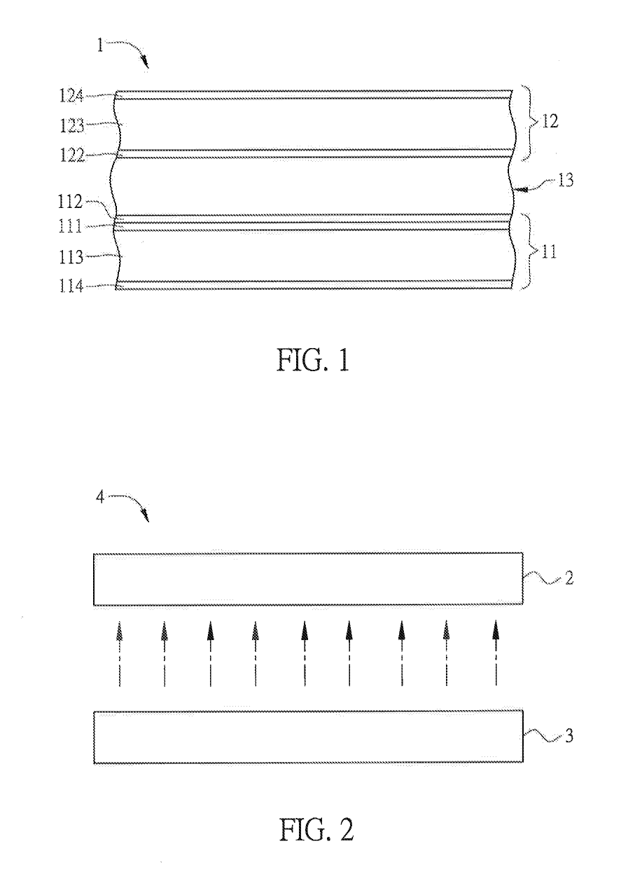

FIG. 1 is a schematic diagram of a liquid crystal display (LCD) panel 1 according to an embodiment of the invention. In the embodiments of the invention, the LCD panel 1 is not limited in type, which can be a display panel of a fringe field switching (HS) type, an in-plane switching (IPS) type, or a vertical alignment (VA) type, for example. The LCD panel 1 includes a first substrate 11, a second substrate 12 and a liquid crystal layer 13. The first and second substrates 11, 12 are disposed oppositely, and the liquid crystal layer 13 is disposed between the first and second substrates 11, 12. The first and second substrates 11, 12 are composed of a color filter (CF) substrate and a thin film transistor (TFT) substrate. Herein for example, the first substrate 11 is a thin film transistor substrate, while the second substrate 12 is a color filter substrate. Besides, the LCD panel 1 may have variations according to other technologies. For example, the color filter layer can be disposed on the TFT substrate (i.e. color filter on array, COA), the color filter layer and the black matrix can be both disposed on the TFT substrate (i.e. black matrix on array, BOA), or the TFT array can be disposed on the CF substrate (i.e. TFT on CF, TOC or array on CF).

The first substrate 11 includes a first alignment layer 112 and a second-type alignment layer 111. The first alignment layer 112 is defined as a first-type alignment layer. The first-type alignment layer can be a photo-induced polymer alignment layer, and the second-type alignment layer can be a polyimide (PI) alignment layer. Herein, the second-type alignment layer 111 is not treated by the alignment process. The first alignment layer 112 is polymerized from monomers including, for example, mono-acrylic monomers, bi-acrylic monomers or a combination thereof. The mono-acrylic monomer is exemplary dodecyl prop-2-enoate, and the chemical structure thereof is as follows:

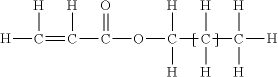

The chemical name of bi-acrylic monomer is such as 4,4′-bisacryloyl-biphenyl, and the chemical structure thereof is as follows:

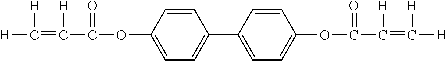 [SMILES: C=CC(=O)Oc1ccc(-c2ccc(OC(=O)C=C)cc2)cc1]

Besides, The chemical name of bi-acrylic Monomer also can be 4,4′-bis[4-(acryloyxy)hexyloxy]biphenyl for example, and the chemical structure thereof is as follows:

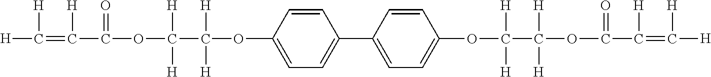 [SMILES: C=CC(=O)OCCOc1ccc(-c2ccc(OCCOC(=O)C=C)cc2)cc1]

Moreover, the first substrate 11 further includes a substrate body 113 and a polarizing element 114. The elements included in the substrate body 113 may be various according to different types of LCD panels or applied technologies. For example, the substrate body 113 may include a substrate, a TFT array and a pixel electrode layer, etc. The above-mentioned substrate may be a glass substrate, a tempered glass substrate, or a plastic substrate. The polarizing element 114 is attached to a side of the substrate body 113 away from the liquid crystal layer 13. The second-type alignment layer 111 and the first alignment layer 112 are disposed on a side of the substrate body 113 close to the liquid crystal layer 13. The first alignment layer 112 is disposed between the second-type alignment layer 111 and the liquid crystal layer 13, and contacts the liquid crystal layer 13. In this embodiment, for making the LCD panel 1 a batter transmittance, the second-type alignment layer 111 would better be made thinner, and here is configured with a thickness preferably between 100-1000 angstroms for example. Compared with the conventional polyimide alignment layer thicker than 1000 angstroms, by thinning the second-type alignment layer 111 according to the embodiment, the second-type alignment layer 111 becomes thinner, such that the transmittance of the LCD panel 1 becomes higher than the conventional case. The thickness of the first alignment layer 112 can be less than 50 angstroms.

The second substrate 12 includes a second alignment layer 122, which is also defined as the first-type alignment layer. Moreover, the second substrate 12 further includes a substrate body 123 and a polarizing element 124. With different types of the LCD panel 1 or applied technologies, the elements included by the substrate body 123 are varied accordingly. For example, the substrate body 123 can include a substrate, a black matrix, a color filter layer, and a common electrode layer, etc. The above-mentioned substrate can be a glass substrate, a tempered glass substrate, or a plastic substrate. The polarizing element 124 is attached to a side of the substrate body 123 away from the liquid crystal layer 13. The second alignment layer 122 is disposed on a side of the substrate body 123 close to the liquid crystal layer 13, and contacts the liquid crystal layer 13. In this embodiment, the thickness of the second alignment layer 122 can be less than 50 angstroms.

The manufacturing method of the LCD panel 1 is illustrated as below. First, the first and second substrates 11, 12 are attached and aligned to each other, and a liquid crystal mixture is disposed therebetween, where the first substrate 11 has a second-type alignment layer 111, which can be exemplary a polyimide alignment layer. The liquid crystal mixture can be formed between the two substrates by injection method or one drop fill (ODF) method. The liquid crystal mixture includes a liquid crystal material, a plurality of monomers and a photoinitiator. The monomers include, for example, mono-acrylic monomers, bi-acrylic monomers, or a combination thereof. The chemical structure of the monomer is clearly illustrated as above and is not described here for conciseness. The photoinitiator includes phenyl ketone, whose chemical name is such as 1-hydroxy-cyclohexylphenyl-ketone with the chemical structure as follows:

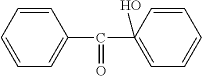

The weight percentage of combination of the mono-acrylic monomer and the bi-acrylic monomer in the liquid crystal mixture is preferably less than 4%. More preferably, the weight percentage of the mono-acrylic monomer is between 1.8-3.6%, the weight percentage of the bi-acrylic monomer is between 0.3-0.64%, and the weight percentage of the photoinitiator is less than 1%. More preferably, the weight percentage of the photoinitiator is between 0.1-0.2%.

Then, an electric filed is applied to the pixel electrode of the first substrate 11 and the common electrode of the second substrate 12 to tilt the liquid crystal to a required direction. At the same time, the first and second substrates 11, 12 are illuminated by a light source. The light source may emit light with a wide range of wavelength. For example, the light source may be an ultraviolet light source such as medium-pressure, high-pressure or ultra-high pressure mercury-vapor lamp. The wavelength of the light source is exemplary between 100-400 nm. The monomers will be polymerized by illumination, and thus the first alignment layer 112 and the second alignment layer 122 are respectively formed on the first substrate 11 and the second substrate 12, and the liquid crystal mixture becomes the liquid crystal layer 13. The first alignment layer 112 and the second alignment layer 122 are photo-induced polymer alignment layers. To be noted, there may be some monomers remaining in the liquid crystal layer 13.

FIG. 2 is a schematic diagram of a liquid crystal display apparatus 4 according to an embodiment of the invention. The LCD apparatus 4 includes an LCD panel 2 and a backlight module 3. The LCD panel 2 can be any of the foregoing LCD panels, and is disposed opposite to the backlight module 3 which emits light into the LCD panel 2. In this embodiment, the backlight module 3 is exemplary a top-down or side-edge type and is not limited thereto.

In summary, in the LCD panel and the LCD apparatus according to the embodiments of the invention, a second-type alignment layer such as polyimide alignment layer is only disposed on one substrate, and therefore the effectiveness of alignment can be enhanced when the PI-less process is conducted, so as to improve the yield and display quality by preventing bright dots and lines from occurring in the dark state.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display panel, comprising:
a first substrate having a first alignment layer;
a second substrate disposed opposite to the first substrate, the second substrate having a second alignment layer; and
a liquid crystal layer disposed between the first substrate and the second substrate, the first alignment layer and the second alignment layer contacting the liquid crystal layer;
wherein the first alignment layer and the second alignment layer are defined as first-type alignment layers, and either the first substrate or the second substrate has a second-type alignment layer.

2. The liquid crystal display panel as recited in claim 1, wherein the first and second substrates are composed of a color filter substrate and a thin film transistor substrate.

3. The liquid crystal display panel as recited in claim 1, wherein the first-type alignment layer is a photo-induced polymer alignment layer, and the second-type alignment layer is a polyimide alignment layer.

4. The liquid crystal display panel as recited in claim 1, wherein the first-type alignment layer is disposed between the second-type alignment layer and the liquid crystal layer.

5. The liquid crystal display panel as recited in claim 1, wherein the first-type alignment layer is polymerized from a plurality of monomers.

6. The liquid crystal display panel as recited in claim 5, wherein the plurality of monomers comprise mono-acrylic monomers, bi-acrylic monomers or a combination thereof.

7. The liquid crystal display panel as recited in claim 6, wherein the mono-acrylic monomers are dodecyl prop-2-enoate.

8. The liquid crystal display panel as recited in claim 6, wherein the bi-acrylic monomers are 4,4′-bisacryloyl-biphenyl or 4,4′-bis[4-(acryloyxy) hexyloxy]biphenyl.

9. The liquid crystal display panel as recited in claim 1, wherein the thickness of the second-type alignment layer is between 100-1000 angstroms (Å).

10. The liquid crystal display panel as recited in claim 1, wherein the thickness of at least one of the first and second alignment layers is less than 50 angstroms.

11. A liquid crystal display apparatus, comprising:
a backlight module; and
a liquid crystal display panel disposed opposite to the backlight module, the liquid crystal display panel comprising:
a first substrate having a first alignment layer;
a second substrate disposed opposite to the first substrate, the second substrate having a second alignment layer; and
a liquid crystal layer disposed between the first substrate and the second substrate, the first alignment layer and the second alignment layer contacting the liquid crystal layer;
wherein the first alignment layer and the second alignment layer are defined as first-type alignment layers, and either the first substrate or the second substrate has a second-type alignment layer.

12. The liquid crystal display apparatus as recited in claim 11, wherein the first and second substrates are composed of a color filter substrate and a thin film transistor substrate.

13. The liquid crystal display apparatus as recited in claim 11, wherein the first-type alignment layer is a photo-induced polymer alignment layer, and the second-type alignment layer is a polyimide alignment layer.

14. The liquid crystal display apparatus as recited in claim 11, wherein the first-type alignment layer is disposed between the second-type alignment layer and the liquid crystal layer.

15. The liquid crystal display apparatus as recited in claim 11, wherein the first-type alignment layer is polymerized from a plurality of monomers.

16. The liquid crystal display apparatus as recited in claim 15, wherein the plurality of monomers comprise mono-acrylic monomer, bi-acrylic monomer, or a combination thereof.

17. The liquid crystal display apparatus as recited in claim 16, wherein the mono-acrylic monomers are dodecyl prop-2-enoate.

18. The liquid crystal display apparatus as recited in claim 16, wherein the bi-acrylic monomers are 4,4′-bisacryloyl-biphenyl or 4,4′-bis[4-(acryloyxy hexyloxy]biphenyl.

19. The liquid crystal display apparatus as recited in claim 11, wherein the thickness of the second-type alignment layer is between 100-1000 angstroms.

20. The liquid crystal display apparatus as recited in claim 11, wherein the thickness of at east one of the first and second alignment layers is less than 50 angstroms.
